(19) United States
(12) Patent Application Publication
(10) Pub. No.: US 2008/0269442 A1
(43) Pub. Date: Oct. 30, 2008

(54) CATIONIC PERAMIDO TITANIUM POLYMERIZATION CATALYSTS

(76) Inventors: John F. C. Turner, Brighton (GB); Michael A. Blanchard, Lakemoor, IL (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/055,821

(22) Filed: Mar. 26, 2008

Related U.S. Application Data
(60) Provisional application No. 60/919,964, filed on Mar. 26, 2007.
(60) Provisional application No. 60/993,879, filed on Sep. 14, 2007.

(51) Int. Cl. B01J 31/22; C08F 4/44

(52) U.S. Cl. 526/134; 526/154; 502/152

(57) ABSTRACT

The presently disclosed subject matter relates to tris(N,N-diarylamido) transition metal complexes and the use of such complexes as single-site polymerization catalysts. The presently disclosed complexes can be used as catalysts in the preparation of polymers from monomers, such as olefins and propylene oxide, at relatively low pressure and temperature. The polymers produced have a high molecular weight.

### RELATED APPLICATIONS

The presently disclosed subject matter claims the benefit of U.S. Provisional Patent Application Ser. No. 60/919,964, filed Mar. 26, 2007; and U.S. Provisional Patent Application Ser. No. 60/993,879, filed Sep. 14, 2007; the disclosure of each of which is incorporated herein by reference in its entirety.

### GOVERNMENT INTEREST

This presently disclosed subject matter was made with U.S. Government support under Grant No. CHE 0349010 awarded by the National Science Foundation. Thus, the U.S. Government has certain rights in the presently disclosed subject matter.

### TECHNICAL FIELD

The presently disclosed subject matter relates to tris(N,N-diarylamido) transition metal complexes and activated catalyst species derived from the transition metal complexes. The presently disclosed subject matter also relates to methods of using the transition metal complexes or the activated catalysts species to polymerize monomers and to the polymers prepared thereby. In particular, the tris(N,N-diarylamido) transition metal complexes can be used in methods for polymerizing olefins and propylene oxide rapidly under mild conditions.

### ABBREVIATIONS

δ=chemical shift
° C.=degrees Celsius
Ar^{F}=pentafluorophenyl
atm=atmosphere
eq=equivalents
g=grams
Hf=hafnium
Hz=hertz
K=potassium
MAO=methylalumoxane
mbar=millibar
MMAO=modified methylalumoxane
Mg=magnesium
MHz=megahertz
mL=milliliters
mol=moles
m.p.=melting point
ms=millisecond
MS=mass spectroscopy
Mⁿ=number average molecular weight
M_{w}=weight average molecular weight
Mw=average molecular weight
N=tris(diarylamido)
Na=sodium
NMR=nuclear magnetic resonance spectroscopy
PP=polypropylene ppm parts per million
tBu=tert-butyl
THF=tetrahydrofuran
Ti=titanium
TMS=tetramethylsilane
Zr=zirconium

### BACKGROUND

Polymers can be used in a large number of household, industrial, medical, and research applications. In view of the many and varied uses for polymeric materials, a great deal of effort has been aimed at discovering improvements in polymerization processes, for example, to make polymerization methods more efficient and/or to provide polymer products having a particular characteristic or group of characteristics. Accordingly, several different types of ligand-metal complexes have been examined for their ability to catalyze polymerization reactions. Such complexes include metallocenes and complexes comprising bidentate amido ligands.

In spite of the variety of catalysts that have been examined, there still exists a need for the development of new, tunable catalysts and catalyst precursors capable of producing polyolefins and other polymers having predetermined or tailorizable properties. There is also an ongoing need for polymerization catalysts that can be used under mild conditions and with high catalyst activity.

### SUMMARY

The presently disclosed subject matter provides a method of polymerizing a monomer, the method comprising: providing a transition metal complex, the complex having a structure of Formula (I):

X-M-(L)₃ (I)

wherein X is selected from the group consisting of halo, alkyl, aryl, aryloxy, alkoxyl, silyl, and BH₄, M is a transition metal, and each L is independently a monodentate diarylamido ligand; providing an activator, wherein the activator is selected from the group consisting of an alumoxane, a tetraarylboron compound, a triarylboron compound and a combination thereof; providing a monomer; contacting the transition metal complex with the activator to form an activated catalyst species; and contacting the activated catalyst species with the monomer at a pressure and at a temperature for a period of time, thereby polymerizing the monomer to form a polymer.

In some embodiments, one or more or, in some cases, each L has a structure of Formula (II):

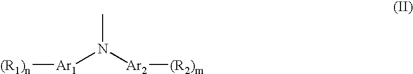

wherein Ar₁ and Ar₂ are independently C₆-C₂₆ aryl groups; n and m are each independently an integer from 5 to 17; and each R₁ and R₂ is independently selected from the group consisting of H, alkyl, halo, nitro, cyano, alkoxyl, acyl, acyloxy, aryl, aryloxy, aralkyl, aralkoxy, and dialkylamino, or an R₁ and an R₂ together are a direct bond or an alkylene.

In some embodiments, one or more or, in some cases, each L has a structure of Formula (III):

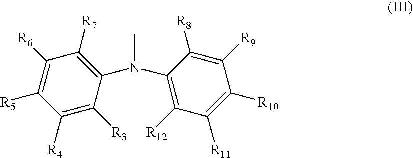

wherein each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino, or R₃ and R₁₂ together are a direct bond or a C₁-C₂ alkylene.

In some embodiments, each of R₃, R₄, R₅, R₆, R₇, R₈, R₉, R₁₀, R₁₁, and R₁₂ is H and one or more or, in some cases, each L has the structure:

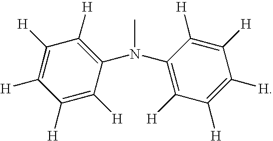

In some embodiments, R₃ and R₁₂ together are a direct bond and one or more or, in some cases, each L has a structure of Formula (IV):

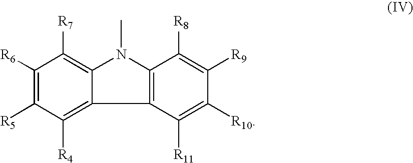

In some embodiments, R₃ and R₁₂ together are alkylene, and one or more or, in some cases, each L has a structure of Formula (V):

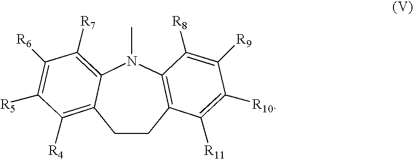

In some embodiments, X is chloro. In some embodiments, X is methyl.

In some embodiments, M is selected from the group consisting of titanium, zirconium, and hafnium. In some embodiments, M is titanium.

In some embodiments, the activator is selected from the group consisting of methyl alumoxane (MAO), tris(pentafluorophenyl)borane, and potassium tetrakis(pentafluorophenyl)borate.

In some embodiments, the monomer is selected from an olefin, propylene oxide, and a combination thereof. In some embodiments, the monomer is selected from the group consisting of propylene, ethylene, propylene oxide and combinations thereof. In some embodiments, the monomer is propylene.

In some embodiments, the polymer is atactic polypropylene.

In some embodiments, the polymer has an average molecular weight (Mw) of about 750,000 or more. In some embodiments, the average molecular weight is about 814,300.

In some embodiments, the polymer has a polydispersity index (PDI) ranging between about 0.9 and about 1.1. In some embodiments, the PDI ranges between about 0.95 and about 1.05.

In some embodiments, contacting the transition metal complex and the activator takes place in a solvent selected from the group consisting of an aryl hydrocarbon, an alkyl hydrocarbon, and a combination thereof.

In some embodiments, contacting the transition metal complex and the activator comprises contacting the transition metal complex with a molar excess of the activator. In some embodiments, contacting the transition metal complex and the activator comprises contacting the transition metal complex with about 25 molar equivalents of the activator.

In some embodiments, the temperature ranges between about −20° C. and about 50° C. In some embodiments, the temperature ranges between about −5° C. and about 30° C. In some embodiments, the temperature ranges between about 20° C. and about 25° C.

In some embodiments, the pressure is about 1 atm or less. In some embodiments, the pressure ranges between about 1 atm and about 0.5 atm.

In some embodiments, the period of time is less than about 30 minutes.

In some embodiments, contacting the activated catalyst species with the monomer provides at least 20 kg of polymer per mole of activated catalyst species. In some embodiments, contacting the activated catalyst species with the monomer provides 26.6 kg of polymer per mole of activated catalyst species.

In some embodiments, the presently disclosed subject matter provides a polymer prepared according to the steps of: providing a transition metal complex having a structure of Formula (I); providing an activator selected from the group consisting of an alumoxane, a tetraarylboron compound, a triarylboron compound and a combination thereof; providing a monomer; contacting the transition metal complex with the activator to form an activated catalyst species; and contacting the activated catalyst species with the monomer at a pressure and at a temperature for a period of time, thereby polymerizing the monomer to form a polymer. In some embodiments, the monomer is selected from an olefin, propylene oxide, and a combination thereof.

In some embodiments, the presently disclosed subject matter provides a transition metal complex having a structure of Formula (I):

X-M-(L)₃ (I)

wherein X is selected from the group consisting of halo, alkyl, aryl, aryloxy, alkoxyl, silyl, and BH₄; M is a transition metal; and each L is independently a monodentate diarylamido ligand; subject to the proviso that the transition metal complex does not have the structure:

Cl—Ti—(N(C₆H₅)₂)₃.

In some embodiments, one or more or, in some cases, each L is independently a monodentate diarylamido ligand having a structure of one of Formula (IV) and Formula (V):

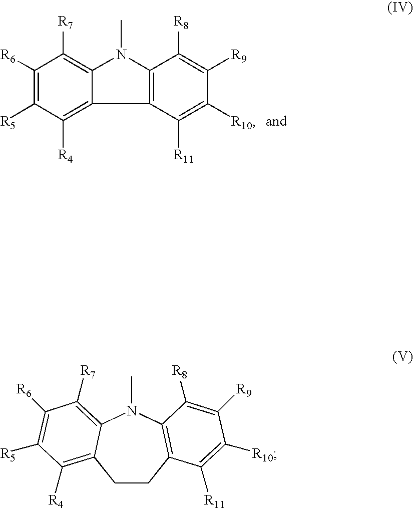

wherein each R₄, R₅, R₆, R₇, R₈, R₉, R₁₀, and R₁₁ are independently selected from the group consisting of H, alkyl, halo, nitro, cyano, alkoxyl, acyl, acyloxy, aryl, aryloxy, aralkyl, aralkoxy, and dialkylamino.

In some embodiments, each R₄, R₅, R₆, R₇, R₈, R₉, R₁₀, and R₁₁ is H. In some embodiments, M is selected from the group consisting of titanium, zirconium, and hafnium. In some embodiments, H is halo or alkyl. In some embodiments, X is chloro. In some embodiments, X is methyl.

In some embodiments, the transition metal complex is selected from the group consisting of:

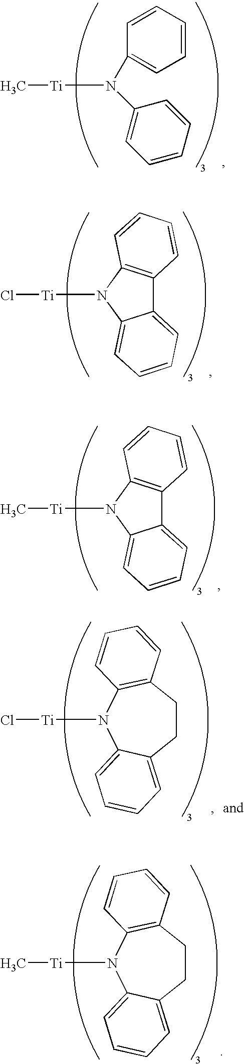

In some embodiments, the presently disclosed subject matter provides an activated catalyst species, wherein the activated catalyst species has a structure of Formula (VI):

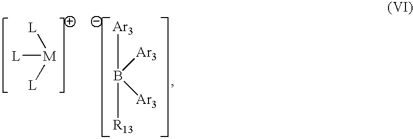

wherein M is a transition metal; each L is a monodentate diarylamido ligand; each Ar₃ is aryl or substituted aryl; and R₁₃ is alkyl, aryl, or substituted aryl.

In some embodiments, each Ar₃ is pentafluorophenyl and R₁₃ is selected from the group consisting of methyl and pentafluorophenyl.

In some embodiments, one or more L has a structure of Formula (III):

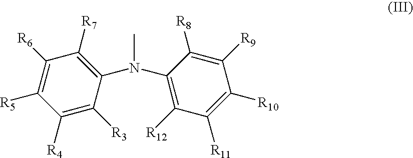

wherein each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or R₃ and R₁₂ together are a direct bond; or R₃ and R₁₂ together are C₁-C₂ alkylene.

In some embodiments, one or more or, in some cases, each L is selected from the group consisting of:

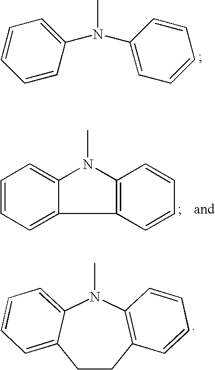

In some embodiments, the activated catalyst species has an activity of about 20 kg of polymer per mole of catalyst or more.

In some embodiments, the presently disclosed subject matter provides a method of polymerizing a monomer, the method comprising providing an activated catalyst species of Formula (VI):

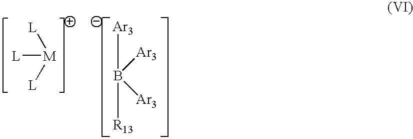

wherein M is a transition metal, each L is a monodentate diarylamido ligand, each Ar₃ is aryl or substituted aryl, and R₁₃ is alkyl, aryl, or substituted aryl; providing a monomer; and contacting the activated catalyst species with the monomer, thereby polymerizing the monomer to form a polymer.

In some embodiments, M is selected from the group consisting of titanium, zirconium, and hafnium. In some embodiments, the monomer is selected from an olefin, propylene oxide, and a combination thereof. In some embodiments, the olefin is propylene. In some embodiments, each Ar₃ is pentafluorophenyl and R₁₃ is selected from the group consisting of methyl and pentafluorophenyl.

In some embodiments, one or more L has a structure of Formula (III):

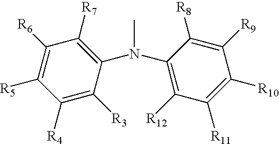

wherein each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or R₃ and R₁₂ together are a direct bond; or R₃ and R₁₂ together are C₁-C₂ alkylene.

In some embodiments, one or more L is selected from the group consisting of:

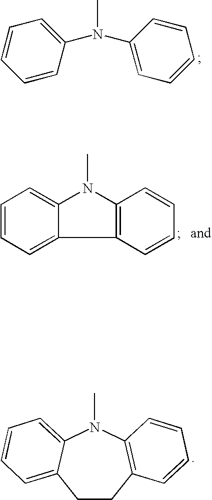

In some embodiments, the contacting is performed at a temperature ranging between about −20° C. and about 50° C. In some embodiments, the temperature ranges between about −5° C. and about 30° C. In some embodiments, the temperature ranges between about 20° C. and about 25° C.

In some embodiments, the contacting is performed at a pressure of about 1 atm or less. In some embodiments, the pressure ranges between about 1 atm and about 0.5 atm.

In some embodiments, the contacting is performed for a period of time of less than about 30 minutes.

In some embodiments, the presently disclosed subject matter provides a polymer, wherein the polymer is prepared by contacting a monomer with an activated catalyst species having a structure of Formula (VI):

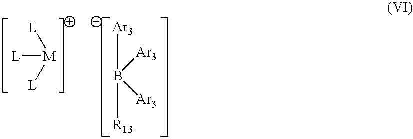

wherein M is a transition metal, each L is a monodentate diarylamido ligand, each Ar₃ is aryl or substituted aryl, and R₁₃ is alkyl, aryl, or substituted aryl.

In some embodiments, the polymer is polypropylene. In some embodiments, the polypropylene has an average molecular weight (Mw) of about 750,000 or more. In some embodiments, the polypropylene has an average molecular weight of about 814,300.

Thus, it is an object of the presently disclosed subject matter to provide methods, transition metal complexes, and activated catalyst species for polymerizing monomers.

An object of the presently disclosed subject matter having been stated hereinabove, and which is achieved in whole or in part by the presently disclosed subject matter, other objects will become evident as the description proceeds when taken in connection with the accompanying Examples as best described hereinbelow.

### DETAILED DESCRIPTION

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist.

### I. Definitions

Following long-standing patent law convention, the terms “a”, “an”, and “the” refer to “one or more” when used in this application, including the claims. Thus, for example, reference to “a monomer” includes mixtures of one or more monomers, two or more monomers, and the like.

Unless otherwise indicated, all numbers expressing quantities of reactants, temperatures, pressures, molecular weights and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the presently disclosed subject matter.

The term “about”, as used herein when referring to a measurable value such as an amount of weight, time, temperature, pressure, etc., is meant to encompass in one example variations of ±20% or ±10%, in another example ±5%, in another example ±1%, and in yet another example ±0.1% from the specified amount, as such variations are appropriate to perform the disclosed methods.

As used herein the term “alkyl” refers to C₁₋₂₀ inclusive, linear (i.e., “straight-chain”), branched, or cyclic, saturated or at least partially and in some cases fully unsaturated (i.e., alkenyl and alkynyl)hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. There can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

“Cyclic” and “cycloalkyl” refer to a non-aromatic mono- or multicyclic ring system of about 3 to about 10 carbon atoms, e.g., 3, 4, 5, 6, 7, 8, 9, or 10 carbon atoms. The cycloalkyl group can be optionally partially unsaturated. The cycloalkyl group also can be optionally substituted with an alkyl group substituent as defined herein, oxo, and/or alkylene. There can be optionally inserted along the cyclic alkyl chain one or more oxygen, sulfur or substituted or unsubstituted nitrogen atoms, wherein the nitrogen substituent is hydrogen, alkyl, substituted alkyl, aryl, or substituted aryl, thus providing a heterocyclic group. Representative monocyclic cycloalkyl rings include cyclopentyl, cyclohexyl, and cycloheptyl. Multicyclic cycloalkyl rings include adamantyl, octahydronaphthyl, decalin, camphor, camphane, and noradamantyl.

The term “aryl” is used herein to refer to an aromatic substituent that can be a single aromatic ring, or multiple aromatic rings that are fused together, linked covalently, or linked to a common group, such as, but not limited to, a methylene or ethylene moiety. In some embodiments, the term aryl specifically refers to a non-heterocyclic aromatic group comprising between 6 and 26 carbon atoms in the ring structure or structures making up the aryl group backbone (i.e., the aromatic ring structure or structures excluding any aryl group substituents, as defined hereinbelow). For example, the aryl group can include monovalent radicals of benzene, naphthalene, anthracene, phenanthrene, chrysene, pyrene, tetracene, benzo[a]anthracene, dibenzo[a,j]anthracene, dibenzo[a,h]anthracene, dibenzo[a,c]anthracene, coronene, fluoranthene, benzo[a]pyrene, benzo[c]phenanthrene, benzo[b]fluoranthene], hexahelicine, and the like. Thus, aryl groups include, but are not limited to, phenyl and napthyl.

The aryl group can be optionally substituted (a “substituted aryl”) with one or more aryl group substituents, which can be the same or different, wherein “aryl group substituent” includes alkyl, substituted alkyl, aryl, substituted aryl, aralkyl, hydroxyl, alkoxyl, aryloxyl, aralkyloxyl, carboxyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, wherein R′ and R″ can each be independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

The term “heteroaryl” refers to any aryl group as defined hereinabove, wherein one or more carbon atoms of the aryl group ring backbone or backbones is replaced by a heteroatom. The heteroatom can be N, S, O, Si, or B. In particular, the term “boraaryl” refers to boron (B)-containing heteroaryl groups. Typical nitrogen-containing heteroaryl groups include, but are not limited to, pyridinyl, indolyl, quinolinyl, and the like.

The term “perfluoro” as used herein to describe an alkyl or aryl group refers to an alkyl or aryl group as defined hereinabove in which every hydrogen (H) atom has been replaced with a fluorine (F) atom. For example, perfluoroaryl groups include perfluorophenyl (i.e., —C₆F₅ or Ar^{F}).

“Alkylene” refers to a straight or branched bivalent aliphatic hydrocarbon group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be unsaturated and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Exemplary alkylene groups include methylene (—CH₂—); ethylene (—CH₂—CH₂—); propylene (—(CH₂)₃—); cyclohexylene (—C₆H₁₀—); —CH═CH—CH═CH—; —CH═CH—CH₂—; —(CH₂)_{q}—N(R)—(CH₂)ᵣ—, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 2 to about 3 carbon atoms and can further have 6-20 carbons.

The terms “carbonyl” and “carboxy” refer to the —C(═O)— group.

The term “carboxylic acid” refer to the —C(═O)OH group. The term “carboxylate” refers to the deprotonated anion of a carboxylic acid (i.e., —C(═O)O⁻).

The term “hydroxyl” refers to the —OH group.

As used herein, the term “acyl” refers to a aryl or alkyl carboxylic acid (i.e., R—C(═O)OH, wherein R is alkyl, substituted alkyl, aryl or substituted aryl) wherein the hydroxyl has been replaced with another substituent. Thus, an acyl group can be represented by the formula RC(═O)—, wherein R is an alkyl or an aryl group as defined herein. As such, the term “acyl” specifically includes arylacyl groups, such as an acetylfuran and a phenacyl group. Additional specific examples of acyl groups include, but are not limited to, acetyl (i.e., CH₃C(═O)—) and benzoyl (i.e., (C₆H₅C(═O)—).

“Alkoxy” and “alkoxyl” refer to an alkyl-O— group wherein alkyl is as previously described. The term “alkoxyl” as used herein can refer to, for example, methoxyl, ethoxyl, propoxyl, isopropoxyl, butoxyl, t-butoxyl, and pentoxyl. The term “oxyalkyl” can be used interchangably with “alkoxyl” or “alkoxy”.

“Aryloxy” and “aryloxyl” refer to an aryl-O— group wherein the aryl group is as previously described, including a substituted aryl. The term “aryloxyl” as used herein can refer to phenyloxyl or hexyloxyl, and alkyl, substituted alkyl, halo, or alkoxyl substituted phenyloxyl or hexyloxyl.

“Aralkyl” refers to an aryl-alkyl-group wherein aryl and alkyl are as previously described, and included substituted aryl and substituted alkyl. Exemplary aralkyl groups include benzyl, phenylethyl, and naphthylmethyl.

“Aralkyloxyl,” “aralkoxyl” and “aralkoxy” refer to an aralkyl-O— group wherein the aralkyl group is as previously described. An exemplary aralkyloxyl group is benzyloxyl.

“Dialkylamino” refers to an —NRR′ group wherein each of R and R′ is independently an alkyl group and/or a substituted alkyl group as previously described. Exemplary alkylamino groups include ethylmethylamino, dimethylamino, and diethylamino.

“Alkoxycarbonyl” refers to an alkyl-O—CO— group. Exemplary alkoxycarbonyl groups include methoxycarbonyl, ethoxycarbonyl, butyloxycarbonyl, and t-butyloxycarbonyl.

“Aryloxycarbonyl” refers to an aryl-O—CO— group. Exemplary aryloxycarbonyl groups include phenoxy- and naphthoxy-carbonyl.

“Aralkoxycarbonyl” refers to an aralkyl-O—CO— group. An exemplary aralkoxycarbonyl group is benzyloxycarbonyl.

“Carbamoyl” refers to an H₂N—CO— group.

“Alkylcarbamoyl” refers to a R′RN —CO— group wherein one of R and R′ is hydrogen and the other of R and R′ is alkyl and/or substituted alkyl as previously described.

“Dialkylcarbamoyl” refers to a R′RN—CO— group wherein each of R and R′ is independently alkyl and/or substituted alkyl as previously described.

“Acyloxyl” and “acyloxy” refer to an acyl-O— group wherein acyl is as previously described. Thus, for example, an acyloxy group can have the structure R—C(═O)—O— wherein R is alkyl, substituted alkyl, aryl or substituted aryl.

“Acylamino” refers to an acyl-NH— group wherein acyl is as previously described.

The term “amino” refers to the —NH₂ group.

The term “amido” as used herein refers to a metal ligand in which a nitrogen atom coordinates to a metal atom. Thus, for example, “diarylamido” refers to a group having the structure —NRR′, wherein both R and R′ are aryl or substituted aryl (i.e., a diarylamino group).

The terms “halo”, “halide”, or “halogen” as used herein refer to fluoro (F), chloro (Cl), bromo (Br), and iodo (I) groups.

The term “hydroxyalkyl” refers to an alkyl group substituted with an —OH group. Hydroxyalkyl groups, include, but are note limited to, hydroxymethyl (i.e., —CH₂OH).

The term “mercapto” refers to the —SH group.

The term “oxo” refers to a compound described previously herein wherein a carbon atom is replaced by an oxygen atom.

The term “nitro” refers to the —NO₂ group.

The term “cyano” refers to the —CN group, wherein the carbon and nitrogen atoms are joined by a triple bond.

The term “thio” refers to a compound described previously herein wherein a carbon or oxygen atom is replaced by a sulfur atom.

The term “sulfate” refers to the —SO₄ group.

The term “silyl” refers to a group having a silicon (Si) atom. Thus, silyl groups include, but are not limited to trialkyl silyl groups (i.e., —SiR₃, wherein each R is an alkyl group, which can be the same or different). R substituents can also include one or more aryl or aralkyl groups.

The term “boryl” refers to a group having a boron (B) atom.

The term “borate” as used herein refers to anions and compounds comprising anions of the formula R₄B⁻, wherein R₄ is an alkyl, substituted alkyl, aryl, or substituted aryl group.

A structure represented generally by a formula such as:

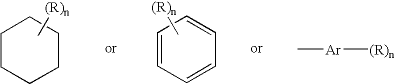

as used herein refers to a ring structure, for example, an aliphatic and/or aromatic cyclic compound comprising a substituent R group, wherein the R group can be present or absent, and when present, one or more R groups can each be substituted on one or more available carbon atoms of the ring structure. The presence or absence of the R group and number of R groups is determined by the value of the integer n. Each R group, if more than one, is substituted on an available carbon of the ring structure rather than on another R group. For example, the structure:

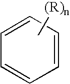

wherein n is an integer from 0 to 2 comprises compound groups including, but not limited to:

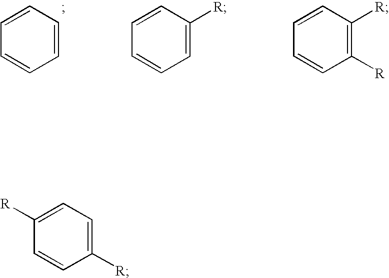

and the like.

When the term “independently” or “independently selected” is used, the substituents being referred to (e.g., R groups, such as groups R₁ and R₂, or L groups), can be identical or different. For example, both R₁ and R₂ can be substituted alkyls, or R₁ can be hydrogen and R₂ can be a substituted alkyl, and the like.

A named “R,” “Ar,” “L,” “M,” or “X” group will generally have the structure that is recognized in the art as corresponding to a group having that name, unless specified otherwise herein. For the purposes of illustration, certain representative “R,” “Ar,” “L,” “M,” and “X” groups as set forth above are defined below. These definitions are intended to supplement and illustrate, not preclude, the definitions that would be apparent to one of ordinary skill in the art upon review of the present disclosure.

The term “transition metal” refers to an element of Groups 3 to 12 of the Periodic Table of the Elements. Thus, transition metals include: scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), meitnerium (Mt), darmstadtium (Ds, formerly ununnillium), roentgenium (Rg, formerly unununium), or ununbium (Uub). In some embodiments the transition metal can also be a lanthanide or an actinide element. In some embodiments, the transition metal is an element of Group 4, 5, or 6 of the Periodic Table of the Elements. In some embodiments, the transition metal is an element of Group 4 of the Periodic Table of the Elements. In some embodiments, the transition metal is titanium, zirconium, or hafnium.

The terms “polymer” and “polymeric” refer to compounds which have repeating units (i.e., multiple copies of a given chemical substructure). Polymers can be formed from polymerizable monomers. A polymerizable monomer is a molecule that comprises one or more reactive moieties that can react to form covalent bonds with reactive moieties on other molecules of polymerizable monomer. Such reactive moieties include, but are not limited to non-aromatic carbon-carbon double bonds, carbon-carbon triple bonds, and epoxides. Generally, each polymerizable monomer molecule can bond to two or more other monomer molecules. In some cases, a polymerizable monomer will bond to only one other monomer molecule, forming a terminus of the polymeric material.

Polymers can include homopolymers, which are prepared from the polymerization of one unique monomer (i.e., all of the monomers that are polymerized have the same chemical structure). Polymers can also include copolymers, prepared from the polymerization of at least two unique monomers, and terpolymers, prepared from three unique monomers. Copolymers can be block copolymers or statistical copolymers. Statistical copolymers are polymers wherein monomer units having different chemical structures are interspersed randomly throughout the polymer. Block copolymers comprise at least two polymeric chains of different monomer composition attached to one another. For example, a block copolymer can comprises a polypropylene chain attached to a polyethylene chain.

The term “olefin” refers to a molecule comprising at least one carbon-carbon double bond, not including bonds in an aromatic ring. In some embodiments, “olefin” refers to C₂-C₂₀ α-olefins. Suitable olefins also include cyclic olefins and conjugated and non-conjugated dienes. Examples of olefins include, but are not limited to, ethylene, propylene, 1-butene, 1-pentene, 1-hexene, 1-octene, 4-methyl-1-pentene, butadiene, isoprene, cyclopentene, cyclohexene, styrene, norbornene, 1-methylnorbornene, 5-methylnorbornene, and the like, and mixtures thereof.

As used herein, the terms “ligand” or “chelating group” refer generally to chemical species, such as a molecules or ions, which interact (e.g., bind) in some way with another species. Thus, the terms “ligand” or “chelating group” can refer to a molecule or ion that binds a metal ion (e.g., a transition metal ion) to form a “coordination complex.”

A “coordination complex” is a chemical species or compound in which there is a coordinate bond between a metal ion and an electron pair donor or other type of electron donor. Thus, ligands for coordination complexes are generally electron donors, molecules or ions having unshared electron pairs or having π bonds that can donate electron density to a metal ion.

The terms “bonding” or “bonded” and variations thereof can refer to either covalent or non-covalent bonding. In some cases, the term “bonding” refers to bonding via a coordinate bond.

The term “coordinate bond” refers to an interaction between an electron donor and a coordination site on a metal ion resulting in an attractive force between the electron donor and the metal ion. The use of this term is not intended to be limiting, in so much as certain coordinate bonds also can be classified as have more or less covalent character (if not entirely covalent character) depending on the characteristics of the metal ion and the electron donor.

The term “coordination site” refers to a point on a metal ion that can form a coordinate bond with another molecule or ion. For example, in some embodiments, the coordination site can interact with an atom having lone pair electrons (e.g., a nitrogen atom), a negatively charged group (i.e., a carboxylate group) or can interact with electrons in the n bond or bonds of an alkene or aryl moiety.

In some embodiments, a metal ion can be coordinated at two or more coordination sites to a single ligand (e.g., via coordinate bonds with two different electron pair donor atoms in the same ligand or via coordinate bonds to one electron pair donor and one π bond system in the same ligand). A ligand capable of forming two coordinate bonds to a metal ion can be referred to as “bidentate.” A ligand that can form only one coordinate bond to a metal ion can be referred to as a “monodentate” ligand.

The term “catalyst” refers to a molecule or chemical species that changes the rate of a chemical reaction (e.g., a bond formation or a bond cleavage). In some embodiments, the term “catalyst” can refer to a transition metal complex (i.e., an unactivated transition metal complex). Thus, in some embodiments, the catalyst is used in conjunction with one or more co-catalysts, activators, or other reagents. In some embodiments, the catalyst is a polymerization catalyst, which catalyzes the formation of a polymer from a monomer or monomers.

In some embodiments, the catalyst can control the stereochemistry of the molecule (e.g., the polymer) that is the product of the chemical reaction. In some embodiments, the polymerization catalysts provided herein will catalyze the polymerization of certain monomers at a higher rate or to the exclusion of other monomers. In some embodiments, the polymerization catalysts provided herein can provide a polymer having a certain length, density, stereochemistry, regiochemistry, glass transition temperature (Tg), tensile strength, or other desired characteristic. In some cases, the polymerization catalysts provided herein can provide a product having a particular polydispersity index (PDI).

The term “single-site catalyst” is used to denote a polymerization catalyst which comprises one catalytically active site. Single-site polymerization catalysts can be used to polymerize monomers having controlled stereochemistry or molecular weight.

The term “activated catalyst species” refers to a chemical species formed from the interaction of a transition metal complex and an activator or co-catalyst.

Propylene oxide refers to the compound having the structure:

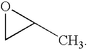

Propylene oxide can be polymerized to form polypropylene oxide (i.e., polypropylene glycol; —[CH₂CH(CH₃)O]ₙ—).

Propene (i.e., CH₂═CHCH₃) is a monomer that can be polymerized to form polypropylene (PP). The tacticity of polypropylene:

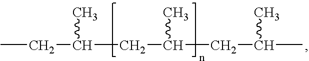

(or other polymers with branching groups) can be referred to as being atactic, isotactic or syndiotactic, based upon the relative orientation (i.e., relative stereochemistry) of the branching groups (e.g., the methyl (—CH₃) groups). In isotactic PP, all of the methyl groups are oriented on the same side of the polymer backbone such that the polymer has a structure:

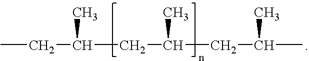

In syndiotactic PP, the neighboring branching groups are oriented on alternate sides of the polymer backbone, i.e., the polymer has a structure:

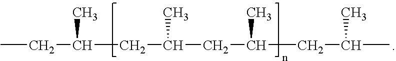

Both isotactic and syndiotactic PP can be relatively crystalline. In atactic PP, the orientation of the methyl groups is random. Atactic PP can be amorphous.

Alkyl and aryl hydrocarbon solvents can include any known alkyl or aryl hydrocarbon based solvent that is suitable for use in polymerization reactions and in preparing activated species of the presently disclosed catalysts. In some embodiments, the alkyl and aryl solvents include, but are not limited to, n-pentane, isopentane, n-hexane, n-heptane, cyclohexane, isododecane, n-octane, n-nonane, n-decane, petroleum ether, benzene, toluene, o-xylene, m-xylene, p-xylene, 1,2,3-trimethylbenzene, 1,2,4-trimethylbenzene, 1,2,5-trimethylbenzene, 1,3,5-trimethylbenzene, ethylbenzene, propylbenzene, and the like.

### II. General Considerations

Ligand-metal coordination complexes (e.g., organometallic complexes or transition metal complexes) and compositions comprising such complexes are useful as catalysts, additives, stoichiometric reagents, monomers, solid state precursors, therapeutic reagents and drugs. In particular, ligand-metal complexes and compositions have been used as catalysts for reactions including oxidation, reduction, hydrogenation, hydrosilylation, hydrocyanation, hydroformylation, polymerization, carbonylation, isomerization, metathesis, carbon-hydrogen activation, carbon-halogen activation, cross-coupling, Friedel-Crafts acylation and alkylation, hydration, dimerization, trimerization, oligomerization, Diels-Alder reactions and other transformations.

Without being bound to any one particular theory, the mechanism for the polymerization of olefins using ligand-metal coordination complexes is believed to involve an intermediate that is capable of inserting an olefin monomer into a bond between the metal and the growing polymer chain. For example, such an intermediate can be formed by coordination of the monomer at an empty coordination site on the metal. Scheme 1, below, illustrates chain growth steps for ethylene polymerization catalyzed by a metal coordination complex comprising n number of ligands, L, and an R group, which becomes the terminus of the growing polymer chain. The open boxes indicate an empty coordination site on the metal.

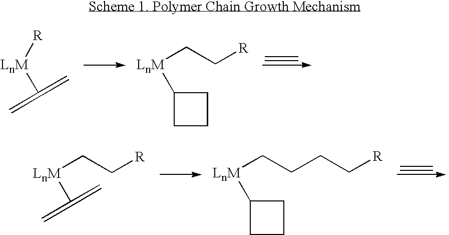

Ligand-metal coordination complexes can be prepared by combining suitable metal compound or metal precursor with a ligand having a functional group or groups that can bind to a metal atom or atoms. In connection with single-site polymerization catalysis, the ligand can offer an opportunity to modify the electronic and/or steric environment surrounding an active metal center of the complex. Thus, the ligands of a transition metal coordination complex catalyst can affect the activity of the catalyst, the relative activity of the catalyst toward different monomers, and the molecular weight, molecular weight distribution, stereochemistry and/or regiochemistry of the polymers produced by the catalyst.

Two types of metal coordination systems that have been widely used in polymerization include metallocenes and Ziegler-Natta catalysts. The active species of these two types of catalysts are shown in Scheme 2, below. As in Scheme 1, above, the open box indicates the vacant coordination site that can coordinate an incoming monomer.

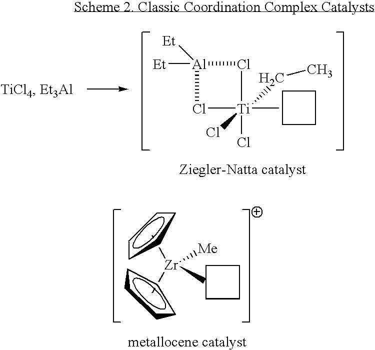

Classic metallocene single-site polymerization catalysts comprise at least two π-bonded groups (e.g., cyclopentyldienyl, indenyl, fluorenyl, etc.) associated with a metal center. Catalysts having a single π-electron donor have also been described. For example, metal coordination catalysts can have a bridged bidentate ligand which comprises a single cyclopentyldienyl group donor group linked to a second σ-electron donor group (e.g., an electron pair donor). See U.S. Pat. Nos. 5,064,802; 5,631,391; and 7,105,690. See also, Jordan, Adv. Organometallic Chem., 32, 325-153 (1991) and Brintzinger, et al., Angew. Chem. Int. Ed. Engl., 34, 1143-1170 (1995). Still other single-site ligand-metal polymerization catalysts have been described which comprise nitrogen-containing heteroaryl π-bonding ligands (see U.S. Pat. No. 6,265,504), π-bonding boraaryl ligands (see U.S. Pat. No. 6,294,626), bidentate pyridyl amido ligands (see U.S. Pat. No. 7,122,689), bidentate bis-amido ligands (see U.S. Pat. No. 5,318,935) and bidentate alpha di-imine ligands (see U.S. Pat. No. 5,866,663).

### III. Tris(Diarylamido) Transition Metal Complexes

The presently disclosed subject matter provides polymerization catalysts based on transition metal complexes comprising monodentate diarylamido (i.e., Ar₂N—) ligands. In some embodiments, the transition metal complex is a tris(diarylamido) transition metal complex.

Diarylamido ligands of the presently disclosed transition metal complexes are strong σ electron donors, but relatively weak π electron donors. Thus, it is believed that the diarylamido ligands coordinate to the metal ion preferentially via σ electron donation from the nitrogen lone pair. The aryl portion of the ligand can provide a wide range of steric bulk about the metal center of the complex. Thus, in view of the availability of a variety of aryl groups, transition metal complex catalysts comprising diarylamido ligands are easily tunable. The diarylamido transition metal complexes are also easily synthesized, inexpensive, soluble in a large variety of solvents and are fairly stable. For example, tris(diarylamido) metal complexes are relatively resistant to oxidation.

In some embodiments, the presently disclosed subject matter provides a transition metal complex having a structure of Formula (I):

X-M-(L)₃ (I)

wherein:

X is selected from the group consisting of halo, alkyl, aryl, aryloxy, alkoxyl, silyl, and BH₄;

M is a transition metal; and

each L is independently a monodentate diarylamido ligand.

In some embodiments, the transition metal complex is a compound of Formula (I), subject to the proviso that the compound is not Cl—Ti—(N(C₆H₅)₂.

In some embodiments, one or more or, in some cases, each L has a structure of Formula (II):

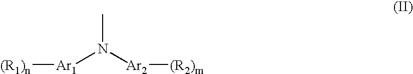

wherein:
Ar₁ and Ar₂ are independently C₆-C₂₆ aryl groups;
n and m are each independently an integer from 5 to 17; and
each R₁ and R₂ is independently selected from the group consisting of H, alkyl, halo, nitro, cyano, alkoxyl, acyl, acyloxy, aryl, aryloxy, aralkyl, aralkoxy, and dialkylamino; or
an R₁ and an R₂ together are a direct bond; or
an R₁ and an R₂ together are alkylene.

Suitable aryl groups can be derived from benzene, naphthalene, anthracene, phenanthrene, chrysene, pyrene, tetracene, benzo[a]anthracene, dibenzo[a,j]anthracene, dibenzo[a,h]anthracene, dibenzo[a,c]anthracene, coronene, fluoranthene, triptycene benzo[a]pyrene, benzo[c]phenanthrene, benzo[b]fluoranthene, hexahelicine, and the like. Thus, in some embodiments, the Ar₁ and Ar₂ are phenyl, napthyl, or anthracenyl. In some embodiments, Ar₁, and Ar₂ are connected to one another via a direct bond or via a linking group, such as an alkylene group (i.e., methylene, ethylene, propylene, butylene, etc). The aryl group substituents (i.e., R₁ and R₂) can be selected so that they will not coordinate to a metal ion well.

In some embodiments, the aryl groups Ar₁ and Ar₂ are both phenyl and one or more or, in some cases, each L has a structure of Formula (III):

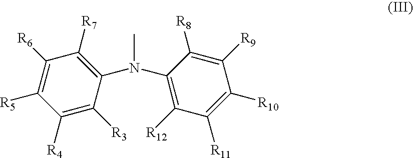

wherein:

each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or

R₃ and R₁₂ together are a direct bond; or

R₃ and R₁₂ together are C₁-C₂ alkylene.

In some embodiments, R₃ and R₁₂ together are a direct bond and one or more or, in some cases, each L has a structure of Formula (IV):

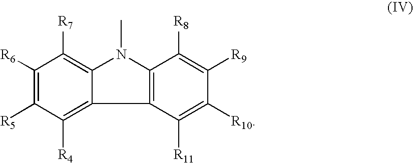

In some embodiments, R₃ and R₁₂ together are alkylene, and one or more or, in some cases, each L has a structure of Formula (V):

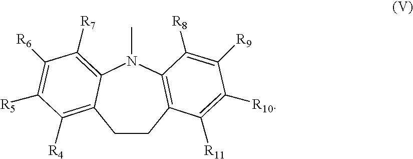

Generally, X is a moiety that can be displaced during a polymerization reaction or during activation of the transition metal complex prior to polymerization. In some embodiments X is a halo group. In some embodiments, X is chloro (Cl). In some embodiments, an alkyl group can be more easily displaced from the metal than a halo group. Thus, in some embodiments, X is alkyl. In some embodiments, X is methyl.

In some embodiments, M is an atom of a Group 4, 5, or 6 element of the Periodic Table. Thus, in some embodiments, M is selected from the group consisting of Ti, Zr, Hf, V, Nb, Ta, Cr, Mo, and W. In some embodiments, M is a Group 4 element selected from Ti, Zr, and Hf. In some embodiments, M is Ti.

In some embodiments, the transition metal complex is selected from the group consisting of:

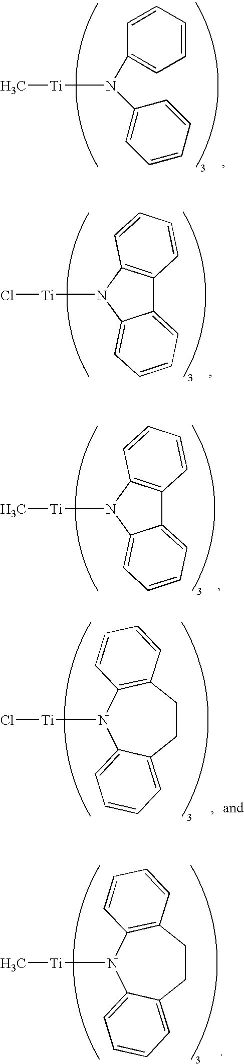

The tris(diarylamido) transition metal complexes can be prepared by first providing (either through purchase from a commercial source or via synthesis) one or more suitable diaryl amine (i.e., (Ar)₂NH). The amine or amines can be combined with a metal atom, ion, compound or other precursor compound. In some embodiments, the amine will be combined with the metal compound or precursor and the product of the combination is isolated and its structure determined prior to further use. In some embodiments, the amine is added to a reaction vessel with titanium or a titanium precursor compound along with a suitable solvent and/or other reagents or scavengers. The amine can be modified prior to addition of or after addition of the metal precursor (e.g., through a deprotonation reaction or other modification).

Suitable titanium precursor compounds can comprise the formula Ti(Xₚ)ₙ, wherein each Xₚ is independently selected from the group consisting of halo, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, oxy, mercapto, amino, phosphine, diene, allyl, seleno, nitrate, sulphate, and combinations thereof. The integer n can be between 1 and 6 (i.e., 1, 2, 3, 4, 5, or 6). The titanium precursor can be monomeric, dimeric, or higher orders thereof. The precursor can contain a small amount of an impurity. For example, the titanium precursor can comprise a small amount of zirconium.

Specific examples of suitable titanium precursors include, but are not limited to, TiCl₄, Ti(CH₂Ph)₄, Ti(CH₂CMe₃)₄, Ti(CH₂SiMe₃)₄, Ti(CH₂Ph)₃Cl, Ti(CH₂CMe₃)₃Cl, Ti(CH₂SMe₃)₂Cl₂, Ti(NMe₂)₄, Ti(NEt₂)₄, Ti(NMe₂)₂Cl₂, Ti(NEt₂)₂Cl₂, Ti(N(SiMe₃)₂)₂Cl₂, Ti(OCH₂CH₃)₄, Ti(OCH(CH₃)₂)₄, TiCl(OCH(CH₃)₂)₃, Ti(OCH₂CH₂CH₂CH₃)₄, Ti(OEt)₄, Ti(N(SiMe₃)₂)₃, and TiCl₃. Lewis base adducts of these precursors are also suitable titanium precursors. The Lewis bases can include ethers, amines, thioethers, phosphines and the like. Examples of Lewis base adducts of titanium precursors include, but are not limited to, TiCl₃(THF)₃ or TiCl₄(NH₃)₂.

### IV. Activated Catalyst Species

The polymerization catalyst compounds of the presently disclosed subject matter are typically activated in various ways to form an activated catalyst species. The term “activator” as used herein refers to any compound or combination of compounds, supported or unsupported, which can activate a transition metal complex of Formula (I). Activators can also be referred to as “co-catalysts.”

Activation can involve the abstraction or displacement of the X group of Formula (I) (e.g., of a halo or alkyl group) from the metal atom, M. Thus, in some embodiments, the activator abstracts a chloro or other leaving group from the transition metal complex. In some embodiments, activation involves forming a partial bond to a leaving group (such as a methyl group), thereby weakening the interaction of the leaving group to the metal center so that it can be more easily displaced by a monomer when the monomer comes into contact with the metal complex. Thus, activation can, but does not necessarily, involve the formation of a transition metal complex comprising an empty coordination site.

The activated catalyst species can be charged or uncharged. In some embodiments, the activated species refers to a salt (i.e., the ion pair formed from a cation of the transition metal complex of Formula (I) and an anion formed from an activator). In some embodiments, the activated species is the cation formed by the abstraction of a leaving group from the transition metal complex of Formula (I). Thus, catalyst activation can involve formation of a cationic, partially cationic, or zwitterionic species, through proton transfer, oxidation or any other suitable activation process. The exact structure of the activated species can be identifiable or non-identifiable.

Suitable activators include, but are not limited to, organoaluminum and organoboron Lewis acids, such as alumoxanes, alkyl aluminum compounds, tetraarylboron compounds, triaryl boron compounds, and other neutral or ionic ionizing activators, including any conventional cocatalysts known in the art.

Alumoxanes are oligomeric compounds containing —[Al(R)—O]ₙ— subunits, wherein R is an alkyl group. Examples of alumoxanes include methylalumoxane (MAO), modified methylalumoxane (MMAO), ethylalumoxane, and isobutylalumoxane. Alumoxanes can be produced by the hydrolysis of trimethylaluminum and a higher trialkylaluminum, such as triisobutylaluminum. MMAO's are generally more soluble in aliphatic solvents and more stable during storage.

The organoboron and organoaluminum compounds can comprise C₁-C₂₀ groups, such as branched or unbranched alkyl or haloalkyl (e.g., methyl, propyl, isopropyl, isobutyl, trifluoromethyl) and unsaturated groups such as aryl or haloaryl (e.g., phenyl, tolyl, benzyl, p-fluorophenyl, 3,5-difluorophenyl, pentachlorophenyl, pentafluorophenyl, 3,4,5-trifluorophenyl, or 3,5-di(trifluoromethyl)phenyl). Specific examples of Lewis acid trialkylaluminum compounds include, but are not limited to, trimethylaluminum, triethylaluminum, triisobutylaluminum, tributylaluminum, tri-n-hexylaluminum, and tri-n-octyl-aluminum. Specific examples of triarylborane Lewis acid compounds include, but are not limited to, trifluoroborane, triphenylborane, tris(4-fluorormethylphenyl)borane, tris(3,5-difluorophenyl)borane, tris(4-fluoromethylphenyl)borane, tris(penta-fluorophenyl)borane, tris(tolyl)borane, tris(3,5-dimethylphenyl)borane, tris(3,5-difluorophenyl)borane and tris(3,4,5-trifluorophenyl)borane.

Suitable ionic co-catalysts comprise non-coordinating anions, including, but not limited to, tetrakis(pentafluorophenyl)borate, tetra(4-fluorophenyl)borate, tetraphenylborate, tetra(tolyl)borate, tetra(dimethylphenyl)borate, tetra(trifluoromethylphenyl)borate, SbF₆⁻, CF₃SO₃⁻, and ClO₄⁻. In some embodiments, the ionic co-catalyst is a tetraarylborane such as, tetrakis(pentafluorophenyl)borate or tetraphenylborate. Various cationic counterions can be used in conjunction with the tetraarylboranes, including Na⁺, K⁺, and Li⁺ and protonated Lewis bases, including protonated cations derived from methylamine, aniline, N,N-dimethylbenzylamine, N,N-dimethylcyclohexylamine, dimethylamine, diethylamine, N-methylaniline, diphenylamine, N,N-dimethylaniline, trimethylamine, triethylamine, tri-n-butylamine, methyldiphenylamine, pyridine, p-bromo-N,N-dimethylaniline, p-nitro-N,N-dimethylaniline, triethylphosphine, triphenylphosphine, diphenylphosphine, tetrahydrothiophene or triphenylcarbenium, and the like.

In some embodiments, the presently disclosed subject matter provides an activated catalyst species, wherein the activated catalyst species has a structure of Formula (VI):

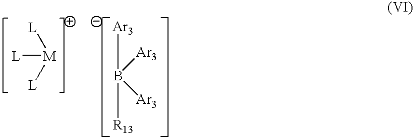

wherein:
M is a transition metal;
each L is a monodentate diarylamido ligand;
each Ar₃ is aryl or substituted aryl; and
R₁₃ is alkyl, aryl, or substituted aryl.

In some embodiments, each Ar₃ is a halo-, alkyl- or haloalkyl-substituted aryl group. In some embodiments, Ar₃ is phenyl, tolyl (i.e., —C₆H₄CH₃), 4-fluorophenyl, dimethylphenyl (e.g., 2,4-dimethylphenyl, 2,3-dimethylphenyl, 3,4-dimethylphenyl, 3,5-dimethylphenyl, 2,5-dimethylphenyl, or 2,6-dimethylphenyl), trifluoromethylphenyl, di(trifluoromethyl)phenyl, tris(trifluoromethyl)phenyl, or pentafluorophenyl. In some embodiments, each Ar₃ group is pentafluorophenyl and R₁₃ is selected from the group consisting of methyl and pentafluorophenyl.

In some embodiments, one or more or, in some cases, each L has a structure of Formula (III):

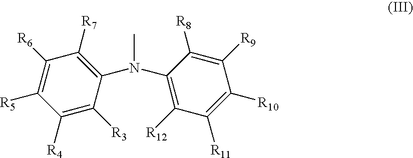

wherein:

each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or

R₃ and R₁₂ together are a direct bond; or

R₃ and R₁₂ together are C₁-C₂ alkylene.

In some embodiments, one or more or, in some cases, each L is selected from among:

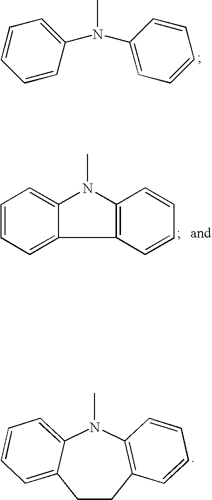

In some embodiments, the activated catalysts species of Formula (VI) is ((C₆H₅)₂N)₃Ti⁺—B(C₆F₅)₄ (i.e., compound 6).

In some embodiments, the activated catalyst species can be used as described hereinbelow to polymerize monomers, such as olefins and/or propylene oxide. In some embodiments, the activated catalyst species can have an activity of about 20 kg of polymer per mole or more.

### V. Methods of Polymerizing a Monomer

V.A. Methods of Polymerizing a Monomer With a Transition Metal Complex

In some embodiments, the presently disclosed subject matter provides a method of polymerizing a monomer using a tri(diarylamido) metal complex or an activated catalyst species derived therefrom.

In some embodiments, the presently disclosed subject matter provides a method of polymerizing a monomer wherein the method comprises:

providing a transition metal complex having a structure of Formula (I):

X-M-(L)₃ (I),

wherein:

X is selected from the group consisting of halo, alkyl, aryl, aryloxy, alkoxy, silyl, and BH₄;

M is a transition metal; and

each L is independently a monodentate diarylamido ligand;

providing an activator selected from the group consisting of an alumoxane, a tetraarylboron compound, a triarylboron compound and a combination thereof;

providing a monomer;

contacting the transition metal complex with the activator to form an activated catalyst species; and contacting the activated catalyst species with the monomer at a pressure and at a temperature for a period of time, thereby polymerizing the monomer to form a polymer.

In some embodiments, one or more or, in some cases, each L can have a structure of Formula (II):

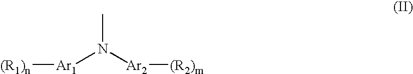

wherein:
Ar₁ and Ar₂ are independently C₆-C₂₆ aryl groups;
n and m are each independently an integer from 5 to 17; and
each R₁ and R₂ is independently selected from the group consisting of H, alkyl, halo, nitro, cyano, alkoxyl, acyl, acyloxy, aryl, aryloxy, aralkyl, aralkoxy, and dialkylamino; or
an R₁ and an R₂ together are a direct bond; or
an R₁ and an R₂ together are alkylene.

In some embodiments, Ar₁ and Ar₂ are phenyl and one or more or, in some cases, each L has a structure of Formula (III):

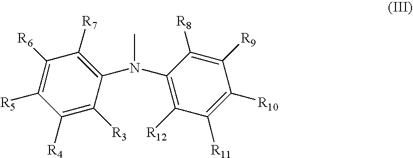

wherein:

each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or

R₃ and R₁₂ together are a direct bond; or

R₃ and R₁₂ together are C₁-C₂ alkylene.

In some embodiments, each of R₃, R₄, R₅, R₆, R₇, R₈, R₉, R₁₀, R₁₁, and

R₁₂ is H and one or more or, in some cases, each L has the structure:

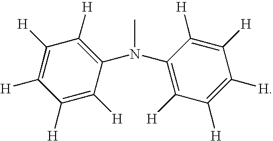

In some embodiments, R₃ and R₁₂ together are a direct bond and one or more or, in some cases, each L has a structure of Formula (IV):

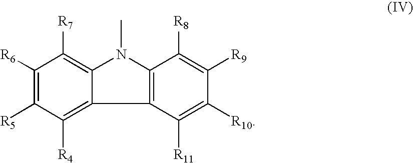

In some embodiments, R₃ and R₁₂ together are alkylene (e.g., methylene, ethylene, propylene, butylene, etc). In some embodiments, one or more or, in some cases, each L has a structure of Formula (V):

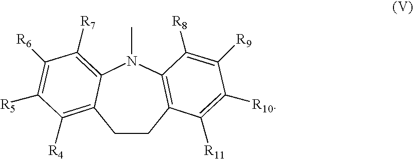

Generally, X is a moiety that can be displaced during a polymerization reaction or during activation of the transition metal complex prior to polymerization. In some embodiments X is a halo group. In some embodiments, X is chloro (Cl). In some embodiments, an alkyl group can be more easily displaced from the metal than a halo group. Thus, in some embodiments, X is alkyl. In some embodiments, X is methyl.

In some embodiments, M is an atom of a Group 4, 5, or 6 element of the Periodic Table. Thus, in some embodiments, M is selected from the group consisting of Ti, Zr, Hf, V, Nb, Ta, Cr, Mo, and W. In some embodiments, M is a Group 4 element selected from Ti, Zr, and Hf. In some embodiments, M is Ti.

The activator can be any alumoxane, tetraarylborane or triarylborane, as described hereinabove or as known in the art. In some embodiments, the activator is selected from MAO, MMAO, ethylalumoxane, and isobutylalumoxane. In some embodiments, the activator is selected from trifluoroborane, triphenylborane, tris(4-fluorormethylphenyl)borane, tris(3,5-difluorophenyl)borane, tris(4-fluoromethylphenyl)borane, tris(penta-fluorophenyl)borane, tris(tolyl)borane, tris(3,5-dimethylphenyl)borane, tris(3,5-difluorophenyl)borane and tris(3,4,5-trifluorophenyl)borane. In some embodiments, the activator is selected from tetrakis(pentafluorophenyl)borate, tetra(4-fluorophenyl)borate, tetraphenylborate, tetra(tolyl)borate, tetra(dimethylphenyl)borate, and tetra(trifluoromethylphenyl)borate. In some embodiments, the activator is selected from the group consisting of MAO, tris(pentafluorophenyl)borane, and potassium tetrakis-(pentafluorophenyl)borate.

In some embodiments, the monomer is selected from the group consisting of an olefin, propylene oxide, and a combination thereof. Suitable olefin monomers for use according to the presently disclosed methods include any C₂-C₂₀ olefin, including, but not limited to ethylene, propylene, 1-butene, 1-pentene, 1-hexene, 1-octene, 4-methyl-1-pentene, butadiene, isoprene, cyclopentene, cyclohexene, styrene, norbornene, 1-methylnorbornene, 5-methylnorbornene, and the like, and mixtures thereof. In some embodiments, the monomer is selected from the group consisting of propylene, ethylene, propylene oxide and combinations thereof. In some embodiments, the monomer is propylene.

In some embodiments, contacting the transition metal complex with the activator can take place in a solvent. The solvent can be an alkyl or aryl hydrocarbon as described hereinabove. In some embodiments, the solvent can be a mixture of alkyl and/or aryl hydrocarbons. Suitable solvents can comprise, for example, hexane, benzene, toluene, and mixtures thereof.

The transition metal complex and the activator can be mixed together in any suitable ratio. In some embodiments, the transition metal complex is contacted with a molar excess of the activator. For example, the transition metal complex can be contacted with up to about 100 molar equivalents of activator (i.e., 100 moles of activator for every 1 mole of transition metal complex). In some embodiments, the transition metal complex is contacted with up to about 50 molar equivalents of activator. In some embodiments, the transition metal complex is contacted with about 25 molar equivalents of the activator. In some embodiments, the transition metal complex is contacted with between about 2 molar equivalents and about 20 molar equivalents (i.e., about 2, 3, 4, 5, 6, 7, 8, 9, 10, 11, 12, 13, 14, 15, 16, 17, 18, 19, or 20 molar equivalents) of the activator. In some embodiments, the transition metal complex and the activator can be contacted in equimolar amounts (i.e., a 1/1 molar ratio).

If necessary, heating or cooling can be provided during the contacting of the transition metal catalyst and the activator. The formation of the activated catalyst species can take place within about a few seconds (i.e., between about 1 and about 59 seconds), within about a few minutes (i.e., about 5, 10, 15, 20, 30, 45, or 50 minutes), or within about a few hours (e.g., between about 1 hour and about 48 hours).

In some embodiments, the activated catalyst species can be isolated and further used in a dry powder or other solid form. In some embodiments, the activated catalyst species is not isolated, and the polymerizable monomer is provided to a mixture comprising the activated catalyst species. The monomer can be provided to a reaction vessel before, at the same time as, or after, the introduction of one or both of the transition metal complex and the activator.

The contacting of the monomer and the activated catalyst species can be performed in a solution, in a slurry, in a suspension, in a gas phase, or in a solid phase. The activated catalyst composition can be supported or unsupported. Thus, in some embodiments, the transition metal complex, the activator, or the activated catalyst species can be provided in association (either covalently or non-covalently) with a solid support material. The support can be organic or inorganic. Typical supports include, for example, silica, carbon black, polyethylene, polycarbonate porous crosslinked polystyrene, porous crosslinked polypropylene, alumina, thoria, zirconia, and magnesium halide (e.g., magnesium dichloride), as well as other well known support materials and mixtures.

In some embodiments, the contacting of the activated catalyst species and the monomer is performed in a liquid mixture comprising the activated catalyst species. The mixture can comprise a suitable solvent, such as an alkyl or aryl hydrocarbon, as described hereinabove. The solvent can also comprise mixtures of alkyl and/or aryl hydrocarbons. The activated catalysts can be dissolved in or suspended in the solvent. The monomer can be provided to this liquid mixture as gas, a gas mixture containing the monomer and a carrier (i.e., inert) gas, as a neat liquid, dissolved in a solution (e.g., a solution comprising the same solvent as used in mixing the transition metal complex and activator or in a solvent system miscible therein), or as a solid.

In some embodiments, the activated catalyst species can be isolated and introduced into a polymerization reaction chamber in a solvent-free state.

In some embodiments, more than one unique monomer is provided. The different monomers can be contacted with the activated catalyst species simultaneously or sequentially.

The contacting of the activated catalyst species and the monomer is performed at a temperature and a pressure sufficient for forming the desired polymer in a suitable amount of time. Generally, the polymerization conditions can be relatively mild, and can involve temperatures and pressures similar to environmental conditions (e.g., room temperature and atmospheric pressure).

In some embodiments, the temperature ranges between about −20° C. and about 50° C. In some embodiments, the temperature ranges between about −5° C. and about 30° C. In some embodiments, the temperature is approximately room temperature (i.e., ranging between about 20° C. and about 25° C.

In some embodiments, the pressure is about 1 atm or less. In some embodiments, the pressure ranges between about 1 atm and about 0.5 atm. In some embodiments, the pressure is about 1 atm.

In some embodiments, contacting the activated catalyst species and the monomer can take place for a period of time ranging from about 1 minute to about 2 hours. In some embodiments, the period of time is less than about 1 hour or less than about 45 minutes. In some embodiments, the period of time is less than about 30 minutes. In some embodiments, the period of time is between about 1 minute and about 20 minutes (i.e., 1, 2, 3, 4, 5, 6, 7, 8, 9, 10, 11, 12, 13, 14, 15, 16, 17, 18, 19, or 20 minutes).

As will be understood by one of skill in the art, the time period, temperature, and pressure of the contacting step can be adjusted as necessary based on the identity of the activated catalyst species, the monomer or monomers, and/or upon one or more desired characteristic related to the polymer provided by the contacting step (e.g., the polymer length or weight). The time period, temperature, and pressure can also be adjusted based upon one or more observations made concerning the progress of the polymerization reaction. For example, progress of a polymerization reaction can be observed by following a decrease in monomer concentration or an increase in the viscosity of a liquid mixture comprising the growing polymer. Polymerization reactions can be monitored via any suitable technique, including, but not limited to, thin layer chromatography (TLC), gas chromatography (GC), mass spectroscopy (MS), nuclear magnetic resonance (NMR) spectroscopy, high pressure liquid chromatography (HPLC), infrared spectroscopy (IR), viscosiometry, gel permeation chromatography, and the like.

The presently disclosed methods provide a very active catalyst. In some embodiments, the amount of polymer formed is at least about 20 kg of polymer per mole of catalyst species (e.g., transition metal complex or activated catalyst species). In some embodiments, that amount of polymer formed is about 26.6 kg of polymer per mole of catalyst.

The polymer prepared according to the methods of the presently disclosed subject matter can comprise a homopolymer, a copolymer or a terpolymer (i.e., a polymer prepared from three unique monomers). In some embodiments, the polymer is a homopolymer such as a polyolefin or polypropylene oxide. In some embodiments, the polyolefin is polyethylene or polypropylene. In some embodiments, the polymer is a block copolymer comprising polyolefin (e.g., polyethylene, polypropylene, etc) and/or polypropylene glycol blocks. In some embodiments, the polymer is a statistical copolymer comprising propylene-, ethylene-, or propylene oxide-derived monomer units or monomer units derived from one or more other olefins. In some embodiments, the polymer is a propylene/ethylene copolymer or a propylene/propylene oxide copolymer. In some embodiments, the polymer is a terpolymer of propylene and two other olefin monomers.

The polymer can be atactic, isotactic, or syndiotactic, or can comprise regions having different types of stereochemistry. In some embodiments, the polymer is atactic polypropylene. The stereochemistry of a polymer can be studied, for example, using nuclear magnetic resonance spectroscopy (NMR) or can be inferred by other polymer characteristics (e.g., crystallinity, etc.)

The presently disclosed methods can provide polymers having a high average molecular weight (Mw). “Average molecular weight” as used herein, generally refers to the number average molecular weight (Mₙ). In some embodiments, the average molecular weight is about 500,000 or more. In some embodiments, the polymer has an average molecular weight of about 750,000 or more. In some embodiments, the polymer (e.g., polypropylene) has an average molecular weight of about 814,300.

The polymers prepared according to the presently disclosed methods can be relatively monodisperse (i.e., have narrow molecular weight distributions). Stated another way, each polymer molecule produced using the same polymerization conditions (e.g., the same transition state complex, activator, monomer(s), temperature, pressure, etc) will have a molecular weight (or polymer length) that is the same as, or close to the same as, the weight of every other polymer molecule produced under the same conditions.

The molecular weight and molecular weight distribution of a polymer can be measured by any suitable approach. For example, the molecular weight and/or the molecular weight distribution can be determined using methods, such as, but not limited to, mass spectroscopy, gel permeation chromatography, viscosiometry, light scattering, and ultracentrifugation. The molecular weight distribution can be expressed in terms of a polydispersity index (PDI).

The PDI of a polymer mixture can be calculated from equation 1:

PDI=M_{w}/Mₙ (equation 1)

wherein M_{w} is the weight average molecular weight and Mn is the number average molecular weight. The closer PDI is to 1, the narrower the molecular distribution of the polymer population.

M_{w} can be calculated according to equation 2:

M_{w}=(ΣᵢNᵢMᵢ²)/(ΣᵢNᵢMᵢ) (equation 2)

wherein Nᵢ is the number of molecules of a polymer in a given population having the molecular weight Mᵢ.

Mₙ (otherwise referred to as the mean or “average molecular weight”) can be calculated according equation 3:

Mₙ=(ΣᵢNᵢMᵢ²)/(ΣᵢNᵢ) (equation 3)

In some embodiments, the polymer has a PDI ranging between about 0.9 and about 1.1. In some embodiments, the PDI ranges between about 0.95 and about 1.05.

V.B. Methods of Polymerizing a Monomer With an Activated Catalyst Species of Formula (VI)

In some embodiments, the presently disclosed subject matter provides a method of polymerizing a polymer wherein the method comprises providing an activated catalyst species having a structure of Formula (VI):

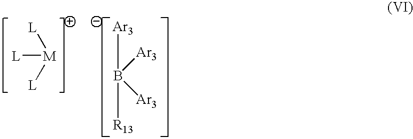

wherein M is a transition metal, each L is a monodentate diarylamine, each Ar₃ is aryl or substituted aryl, and R₁₃ is alkyl, aryl, or substituted aryl; providing a monomer; and contacting the activated catalyst species with the monomer, thereby polymerizing the monomer to form a polymer.

In some embodiments, M is an atom of a Group 4, 5, or 6 element of the Periodic Table. Thus, in some embodiments, M is selected from the group consisting of Ti, Zr, Hf, V, Nb, Ta, Cr, Mo, and W. In some embodiments, M is a Group 4 element selected from Ti, Zr, and Hf. In some embodiments, M is Ti.

In some embodiments, the monomer is selected from the group consisting of an olefin, propylene oxide, and a combination thereof. The olefin monomer can be any C₂-C₂₀ olefin, including, but not limited to ethylene, propylene, 1-butene, 1-pentene, 1-hexene, 1-octene, 4-methyl-1-pentene, butadiene, isoprene, cyclopentene, cyclohexene, styrene, norbornene, 1-methylnorbornene, 5-methylnorbornene, and the like, and mixtures thereof. In some embodiments, the monomer is selected from the group consisting of propylene, ethylene, propylene oxide and combinations thereof. In some embodiments, the olefin monomer is propylene.

In some embodiments, one or more or, in some cases, each Ar₃ is a halo-, alkyl- or haloalkyl-substituted aryl group. In some embodiments, Ar₃ is phenyl, tolyl (i.e., —C₆H₄CH₃), 4-fluorophenyl, dimethylphenyl (e.g., 2,4-dimethylphenyl, 2,3-dimethylphenyl, 3,4-dimethylphenyl, 3,5-dimethylphenyl, 2,5-dimethylphenyl, or 2,6-dimethylphenyl), trifluoromethylphenyl, or pentafluorophenyl. In some embodiments, each Ar₃ group is pentafluorophenyl and R₁₃ is selected from the group consisting of methyl and pentafluorophenyl.

In some embodiments, one or more or, in some cases, each L of Formula (VI) has a structure of Formula (III):

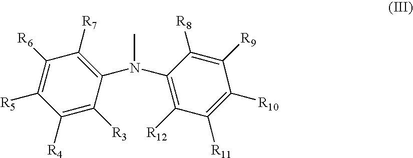

wherein each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or R₃ and R₁₂ together are a direct bond; or R₃ and R₁₂ together are C₁-C₂ alkylene.

In some embodiments, one or more or, in some cases, each L is selected from:

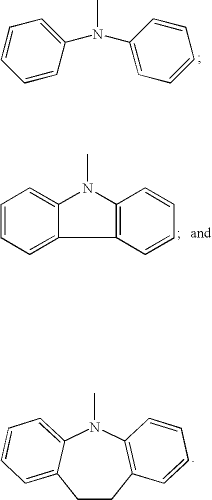

In some embodiments, the activated catalysts species of Formula (VI) is ((C₆H₅)₂N)₃Ti⁺—B(C₆F₅)₄ (i.e., compound 6).

The contacting of the activated catalyst species and the monomer is performed at a temperature and a pressure sufficient for forming the desired polymer in a suitable amount of time. Generally, the polymerization conditions can be relatively mild, and involve temperatures and pressures similar to environmental conditions.

In some embodiments, the temperature ranges between about −20° C. and about 50° C. In some embodiments, the temperature ranges between about −5° C. and about 30° C. In some embodiments, the temperature is approximately room temperature (i.e., ranging between about 20° C. and about 25° C.

In some embodiments, the pressure is about 1 atm or less. In some embodiments, the pressure ranges between about 1 atm and about 0.5 atm. In some embodiments, the pressure is about 1 atm.

In some embodiments, contacting the activated catalyst species and the monomer can take place for a period of time ranging from about 1 minute to about 2 hours. In some embodiments, the period of time is less than about 1 hour or less than about 45 minutes. In some embodiments, the period of time is less than about 30 minutes. In some embodiments, the period of time is between about 1 minute and about 20 minutes (i.e., 1, 2, 3, 4, 5, 6, 7, 8, 9, 10, 11, 12, 13, 14, 15, 16, 17, 18, 19, or 20 minutes).

Contacting conditions (i.e., time, pressure, temperature, etc.) can be adjusted based on the progression of the polymerization reaction or the identity of the reactants (i.e., the activated catalyst species and monomer) as described hereinabove. In some embodiments, the contacting can take place in a solution or a slurry or suspension phase, in the presence of a solvent. The solvent can be an aryl or an alkyl hydrocarbon, as described hereinabove, or mixtures thereof. In some embodiments, the contacting can take place in a gas or solid phase.

The presently disclosed methods provide a very active catalyst. In some embodiments, the amount of polymer formed is at least about 20 kg of polymer per mole of activated catalyst species (e.g., the activated catalysts species). In some embodiments, that amount of polymer formed is about 26.6 kg of polymer per mole of activated catalyst species.

The polymer prepared according to the methods of the presently disclosed subject matter can comprise a homopolymer, a copolymer or a terpolymer. In some embodiments, the polymer is a homopolymer such as a polyolefin or polypropylene oxide. In some embodiments, the polyolefin is polyethylene or polypropylene. In some embodiments, the polymer is a block copolymer comprising polyolefin (e.g., polyethylene, polypropylene, etc) and/or polypropylene glycol blocks. In some embodiments, the polymer is a statistical copolymer comprising propylene-, ethylene-, or propylene oxide-derived monomer units or monomer units derived from one or more other olefins. In some embodiments, the polymer is a propylene/ethylene copolymer or a propylene/propylene oxide copolymer. In some embodiments, the polymer is a terpolymer of propylene and two other olefin monomers.

In some embodiments, the polymer is atactic, isotactic, or syndiotactic, or can comprises select regions having different types of stereochemistry. In some embodiments, the polymer is atactic polypropylene.

In some embodiments, the presently disclosed methods can provide polymers having a high average molecular weight. In some embodiments, the average molecular weight is about 500,000 or more. In some embodiments, the polymer has an average molecular weight of about 750,000 or more. In some embodiments, the polymer (e.g., polypropylene) has an average molecular weight of about 814,300. The polymers prepared according to the presently disclosed methods can comprise relatively narrow molecular weight distributions. In some embodiments, the polymer has a PDI ranging between 0.9 and 1.1. In some embodiments, the PDI ranges between 0.95 and 1.05.

### VI. Polymers and Polymer Applications

In some embodiments, the presently disclosed subject matter provides a polymer prepared by providing a transition metal complex having a structure of Formula (I):

X-M-(L)₃ (I);

providing an activator, wherein the activator is selected from the group consisting of an alumoxane, a tetraarylboron compound, a triarylboron compound and a combination thereof; providing a monomer; contacting the transition metal complex with the activator to form an activated catalyst species; and contacting the activated catalyst species with the monomer at a pressure and at a temperature for a period of time, thereby polymerizing the monomer to form a polymer. In some embodiments, the monomer is selected from the group consisting of an olefin, propylene oxide, and a combination thereof.

In some embodiments, the polymer is prepared using an activated catalyst species having the structure of formula (IV):

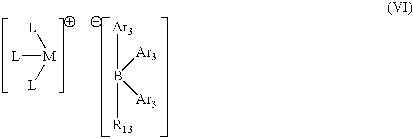

wherein M is a transition metal, each L is a monodentate diarylamine, each Ar₃ is aryl or substituted aryl, and R₁₃ is alkyl, aryl, or substituted aryl.

The polymer can comprise a homopolymer, a copolymer, or a terpolymer. In some embodiments, the polymer is a homopolymer such as a polyolefin or polypropylene oxide. In some embodiments, the polyolefin is polyethylene or polypropylene. In some embodiments, the polymer is a block copolymer comprising polyolefin (e.g., polyethylene, polypropylene, etc) and/or polypropylene glycol blocks. In some embodiments, the polymer is a statistical copolymer (wherein the different monomers are interspersed throughout the polymer) comprising propylene-, ethylene-, or propylene oxide-derived monomer units or monomer units derived from one or more other olefins. In some embodiments, the polymer is a propylene/ethylene copolymer or a propylene/propylene oxide copolymer. In some embodiments, the polymer is a terpolymer of propylene and two other olefin monomers.

The polymer can be atactic, isotactic, syndiotactic, or can comprise select regions having different types of stereochemistry. In some embodiments, the polymer is atactic polypropylene.

In some embodiments, the polymer has a relatively high molecular weight. In some embodiments, the average molecular weight of the polymer is about 500,000 or more. In some embodiments, the polymer has an average molecular weight of about 750,000 or more. In some embodiments, the polymer has an average molecular weight of about 814,300.

In some embodiments, the polymer can have a relatively narrow PDI. In some embodiments, the polymer can have a PDI ranging between about 0.9 and about 1.1. In some embodiments, the polymer can have a PDI ranging between about 0.95 and about 1.05.

The polymers prepared according to the presently disclosed methods can be used for any desired or suitable end use. For example, the polymers of the presently disclosed subject matter and blends prepared from these polymers can be used in applications wherein polyolefins and/or polypropylene oxide are already being used. The end uses include, but are not limited to, packaging films, bags, bottles, containers, foams, coatings, insulating devices and household items.

Depending upon their intended end use and upon their physical properties, the polymers can be employed alone or with other polymers and/or additives in a blend to form products that may be molded, cast, extruded, or spun. The polymers can be blended and/or co-extruded with any other polymer. Non-limiting examples of other polymers include, for example, linear low density polyethylenes produced via conventional Ziegler-Natta and/or metallocene type catalysts, elastomers, plastomers, low density polyethylene, high density polyethylene and polypropylene, and crystalline polypropylene.

Forming operations for the presently disclosed polymers, copolymers, and blends thereof include, but are not limited to, film, sheet, pipe, and fiber extrusion and co-extrusion, blow molding, injection molding, and rotary molding. Films, such as blown or cast films formed by co-extrusion or by lamination, can be used as, for example, shrink film, cling film, stretch film, sealing films, oriented films, snack packaging, trash bags, grocery sacks, baked or frozen food packaging, medical packaging, industrial liners, and membranes for food contact and non-food contact applications. Polymer fibers prepared by melt spinning, solution spinning, or melt blown fiber operations can be used in woven or non-woven forms to make filters, diaper fabrics, medical garments, dressings and drapes, and geotextiles. Extruded polymer articles include tubing (e.g., medical tubing), wire and cable coatings, geomembranes and pond liners. Molded articles include, but are not limited to, single and multi-layered constructions in the form of bottles, tanks, large hollow articles, rigid food containers and toys.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example I

### General Synthetic Procedures

Unless stated otherwise, all solvents were pre-dried over 4A molecular sieves prior to distillation from K₍ₗ₎, (tetrahydrofuran, hexane), K₃Na₍ₗ₎ (diethyl ether, pentane), or Na₍ₗ₎ (toluene, 1,4 dioxane). Solvents for NMR spectroscopy were dried twice via reflux over CaH₂ or K prior to storage over a potassium mirror or the appropriate drying agent where potassium proves reactive with the solvent. All manipulations of solutions were conducted using Schlenk techniques under an argon atmosphere using flamed-dried 316 stainless steel cannulae and flame-dried Schlenk flasks or in an argon-filled glovebox, using standard techniques. Solids were transferred in an argon-filled glove box. In both cases, the concentrations of O₂ and H₂O in the argon atmosphere were less than 5 ppm. Recrystallizations were preformed either through storage of solutions at −21° C. or between −65 and −85° C. or by layering the solution with a solvent in which the solute is insoluble.

Diphenylamine was purchased from commercial sources as a brown to black solid. It was recrystallized once in air from 1:1 toluene/xylenes with at least two successive recrystallizations from toluene under an argon atmosphere. The resultant white crystalline material was then vacuum distilled at approximately 10⁻³ mbar and at approximately 120° C. with the white, amorphous solid being collected at liquid nitrogen temperatures. TiCl₄.(THF)₂ was prepared by treating a solution of doubly distilled TiCl₄ in dichloromethane with a solution of tetrahydrofuran in the same solvent at −80° C. The resultant yellow precipitate was filtered cold and dried. Til₄ was prepared from the titanium and iodine in benzene and purified by Soxhlet extraction in pentane or by sublimation. All other reagents were bought commercially and used as received. Kl, NaI and Lil were dried at 100° C. at 10⁻³ mbar for 24 hours.

¹H NMR spectra were collected at 300 or 400 MHz on either a Bruker INOVA 400 MHz NMR spectrometer (Bruker Biospin Corp., Billerica, Mass., United States of America) or on a Varian Mercury 300 MHz

NMR spectrometer (Varian Inc., Palo Alto, Calif., United States of America), and were referenced to TMS via residual proton resonances in the deuteriated solvent. ¹³C NMR spectra were collected at 300 or 400 MHz on the same spectrometers and were referenced to TMS via the ¹³C resonances of the solvent.

### Example 2

### Synthesis of ((C₆H₅)₂N)₃TiCl, 2, and ((C₆H₅)₂N)₃TiMe, 3

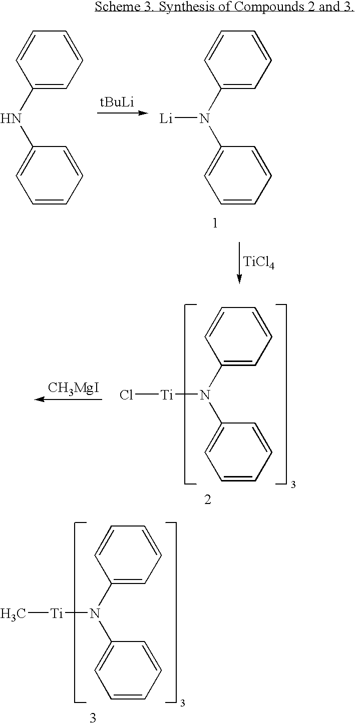

LiN(C₆H₅)₂, 1: As shown in Scheme 3, above, 20 g (0.118 mol, 1 eq) of diphenylamine was dissolved in 300 mL of hexane. 83.4 mL (0.142 mol, 1.2 eq) of 1.7 M t-butyl lithium in hexane (Aldrich) was added drop-wise over a period of 20 minutes. An immediate white precipitate formed and this suspension was allowed to stir at room temperature for 12 hours, at which point it was filtered. The resulting white solid, 1, was washed with 3×20 mL portions of pentane and dried under reduced pressure. ¹H NMR (D₈-THF): δ 6.130 (t, 1H, C₆H₅-para, ³J=7.8 Hz), 6.681 (d, 2H, C₆H₅-ortho, ³J=7.8 Hz), 6.787 (t, 2H, C₆H₅-meta, ³J=7.8 Hz).

((C₆H₅)₂N)₃TiCl, 2: 10.0 g (0.057 mol, 3 eq) of 1 was dissolved in 150 mL of toluene and added drop-wise to a slurry of 6.354 g (0.019 mol, 1 eq) TiCl₄.2THF in 150 mL of toluene over a period of 25 minutes. The color changed to blood red within the first minute. This solution was left to stir at room temperature for a period of 12 hours, upon which time the solution was cooled to −40° C. to allow the salt to settle. The deep red solution was filtered and resulting salt was washed with 3×50 mL portions of hexane. All filtrates were combined and solvent was removed under reduced pressure. The wet product, 2, was recrystallized from pentane. ¹H NMR (D₈-THF): δ 6.8167 (d of t, 2H, C₆H₅-ortho), 6.978 (t of t, 1H, C₆H₅-para), 7.114 (t of t, 2H, C₆H₅-meta). Coupling constants: ⁴J ortho-para=1.2 Hz, ³J para-meta=5.4 Hz, ³J para-meta=6.0 Hz.

((C₆H₅)₂N)₃TiMe, 3: 3.0 g (5.1 mmol, 1 eq) of 2 was dissolved in 100 mL of toluene. Freshly prepared MeMgl (6.1 mmol, 1.2 eq) in dry diethyl ether was added to the first solution over a period of 20 minutes. The resulting solution was allowed to stir at room temperature for 1 hour, at which time 1.079 g (0.0122 mol, 2.4 eq) of 1,4 dioxane was added drop-wise for 2 minutes. An appreciable amount of precipitate forms within the first few drops. After the addition was complete, the solution was allowed to stir for 30 minutes and then allowed to settle. The solution was filtered and left at −80° C. for 12 hours, in which time an orange precipitate formed. The mother solution was filtered from the precipitate, concentrated and placed back into the −80° C. freezer for further precipitation. ¹H NMR (D₈-THF): δ 0.045 (s, 3H, CH₃), 6.9375 (d, 12H, C₆H₅-ortho), 7.7009 (t, 12H, C₆H₅-meta), and 7.194 (t, 6H, C₆H₅-para). Coupling constants: ³J ortho-meta=7.5 Hz, ³J meta-para=7.5 Hz. ¹³C NMR (D₈-THF): δ 65.684, 124.532, 125.361, 130.442, and 148.656. ¹H NMR(C₆D₆): δ 0.424 (d, 3H, CH₃), 6.843 (t of t, 6H, C₆H₅-para), 7.043 (t of t, 12H, C₆H₅-meta), and 7.166 (d of t, 12H, C₆H₅-ortho). ¹³C NMR (C₆D₆) δ 65.509, 124.023, 124.866, 129.953, and 148.006.

### Example 3

### ((C₆H₅)₂N)₃Ti-Me-B(C₆F₅)₃, 4

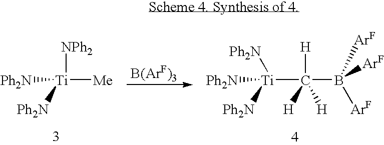

As shown in Scheme 4, above, a solution of B(C₆F₅)₃ (0.450 g, 0.88 mmol, 1 eq) dissolved in 50 mL of hexane was added dropwise over 30 minutes to 0.50 g (8.8 mmol, 1 eq) of 3 in 200 mL of hexane with 10 mL of benzene for solubility. While not all of 3 was dissolved before the reaction, upon completion of the reaction there was no visible solid in the flask. The solution changed from orange to a deep purple red with the addition of the first few drops. The reaction was left to react for 3 hours and at that time all solvent was removed and the purple/red solid 4 was washed with 3×10 mL portions of pentane. Yield: 0.7714 g 4 (83% yield).

### Example 4

### Synthesis of ((C₆H₅)₂N)₃Ti⁺—B(C₆F₅)₄, 6

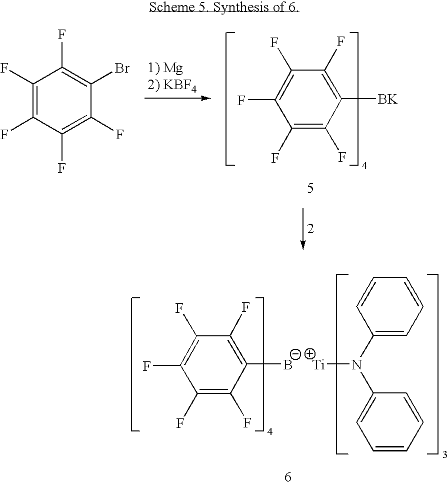

KB(C₆F₅)₄, 5: As shown in Scheme 5 above, fresh BrMgC₆F₅ was prepared from 10.0 g (0.040 mol, 5.047 mL, 1 eq) of BrC₆F₅ was added to 1.181 g (0.0485 mol, 1.2 eq) of activated Mg in 150 mL diethyl ether. The halide was added to the magnesium over a period of 1 hour and the resulting Grignard agent was allowed to stir for 2 hours before use. The freshly prepared Grignard agent was added dropwise to a slurry of 1.2745 g KBF₄ (0.0101 mol, 0.25 eq) in 150 mL of diethyl ether. This solution was allowed to react for 24 hours, at which time, 100 mL of hexane was added to the flask and cooled to −35° C. to enhance precipitation. The solution was filtered cold and the remaining salt was washed with 2×15 mL portions of hexane. The solvent was removed under reduced pressure producing an oily solid, which was washed with 3×20 mL of pentane to give an off-white powder. Yield: 6.87 g (94.5% yield).

((C₆H₅)₂N)₃Ti⁺—B(C₆F₅)₄, 6: 1.00 g (1.7 mmol, 1 eq) of 2 was dissolved in 150 mL of hexane and 25 mL of toluene in a 500 mL round bottom flask. In a separate flask, 1.22 g (1.7 mmol, 1 eq) of 5 was dissolved in 50 mL of hexane and 50 mL of toluene. The second flask was added dropwise over a period of 10 minutes into the first. The reaction was allowed to stir for 2 hours before another 100 mL of hexane was added and placed in the freezer (−40° C.) over night. The next day the solution was filtered through a fine frit and the solvent was removed under reduced pressure to yield a sticky dark red powder. This powder was washed twice with 20 mL portions of pentane and dried under vacuum.

### Example 5

### Propylene Polymerization

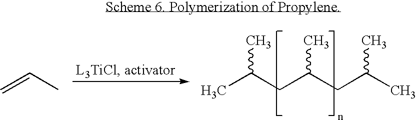

Polypropylene was prepared as shown in Scheme 6, above. The catalyst (e.g., L₃TiCl or L₃TiMe, 0.015 g) and a suitable activator were added to an empty ampoule in the glove box. Catalyst/activator ratios examined included: L₃TiCl: 15 eq MAO; L₃TiCl/1 eq KB(Ar^{F})₄; or L₃TiMe/1 eq B(Ar^{F})₃). The ampoule containing the catalyst and activator was hung on the high vacuum line and 50 mL of toluene was condensed into it. The ampoule and its contents were then chilled to 0° C. and maintained at that temperature for the duration of the reaction. The monomer (e.g., propylene) was added to the vacuum line (static), and the pressure was monitored as the monomer was converted into polymer (e.g. polypropylene). The amount of monomer converted was equal to the pressure of monomer lost.

Molecular weight determinations of the polymer produced from such reactions were run in duplicate on a PL-GPC 220 gel permeation chromatograph (Polymer Laboratories, Amherst, Mass., United States of America) with precision detectors (PD 2040), a static light scatterer, a Viscotek 220 viscosiometer (Viscotek Corporation, Houston, Tex., United States of America), and a Polymer Laboratories 220 refractomer (Polymer Laboratories, Amherst, Mass., United States of America). The molecular weight of polypropylene prepared using 6 as the activated catalyst species was determined to be 8.143×10⁵ Daltons.

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A method of polymerizing a monomer, the method comprising:
providing a transition metal complex, the complex having a structure of Formula (I):
X-M-(L)₃ (I)
wherein:
X is selected from the group consisting of halo, alkyl, aryl, aryloxy, alkoxyl, silyl, and BH₄;
M is a transition metal; and
each L is independently a monodentate diarylamido ligand;
providing an activator, wherein the activator is selected from the group consisting of an alumoxane, a tetraarylboron compound, a triarylboron compound and a combination thereof;
providing a monomer;
contacting the transition metal complex with the activator to form an activated catalyst species; and
contacting the activated catalyst species with the monomer at a pressure and at a temperature for a period of time, thereby polymerizing the monomer to form a polymer.

2. The method of claim 1, wherein each L has a structure of Formula (I): 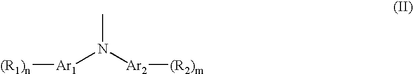
wherein:
Ar₁ and Ar₂ are independently C₆-C₂₆ aryl groups;
n and m are each independently an integer from 5 to 17; and
each R₁ and R₂ is independently selected from the group consisting of H, alkyl, halo, nitro, cyano, alkoxyl, acyl, acyloxy, aryl, aryloxy, aralkyl, aralkoxy, and dialkylamino; or
an R₁ and an R₂ together are a direct bond; or
an R₁ and an R₂ together are alkylene.

3. The method of claim 1, wherein M is selected from the group consisting of titanium, zirconium, and hafnium.

4. The method of claim 1, wherein the activator is selected from the group consisting of methyl alumoxane (MAO), tris(pentafluorophenyl)borane, and potassium tetrakis(pentafluorophenyl)borate.

5. The method of claim 1, wherein the monomer is selected from an olefin, propylene oxide, and a combination thereof.

6. The method of claim 1, wherein the polymer is atactic polypropylene.

7. The method of claim 1, wherein the polymer has an average molecular weight (Mw) of about 750,000 or more.

8. The method of claim 1, wherein the polymer has a polydispersity index ranging between about 0.9 and about 1.1.

9. The method of claim 1, wherein the temperature ranges between about −20° C. and about 50° C.

10. The method of claim 1, wherein the pressure is about 1 atm or less.

11. The method of claim 1, wherein the period of time is less than about 30 minutes.

12. The method of claim 1, wherein contacting the activated catalyst species with the monomer provides at least 20 kg of polymer per mole of activated catalyst species.

13. A polymer, wherein the polymer is prepared according to the steps of:
providing a transition metal complex, the complex having a structure of Formula (I):
X-M-(L)₃ (I)
wherein:
X is selected from the group consisting of halo, alkyl, aryl, aryloxy, alkoxyl, silyl, and BH₄;
M is a transition metal; and
each L is independently a monodentate diarylamido ligand;
providing an activator, wherein the activator is selected from the group consisting of an alumoxane, a tetraarylboron compound, a triarylboron compound and a combination thereof;
providing a monomer;
contacting the transition metal complex with the activator to form an activated catalyst species; and
contacting the activated catalyst species with the monomer at a pressure and at a temperature for a period of time, thereby polymerizing the monomer to form a polymer.

14. A transition metal complex having a structure of Formula (I):
X-M-(L)₃ (I)
wherein:
X is selected from the group consisting of halo, alkyl, aryl, aryloxy, alkoxyl, silyl, and BH₄;
M is a transition metal; and
each L is independently a monodentate diarylamido ligand;
subject to the proviso that the transition metal complex does not have the structure:
Cl—Ti—(N(C₆H₅)₂)₃.

15. The transition metal complex of claim 14, wherein one or more L is independently a monodentate diarylamido ligand having a structure of one of Formula (IV) and Formula (V): 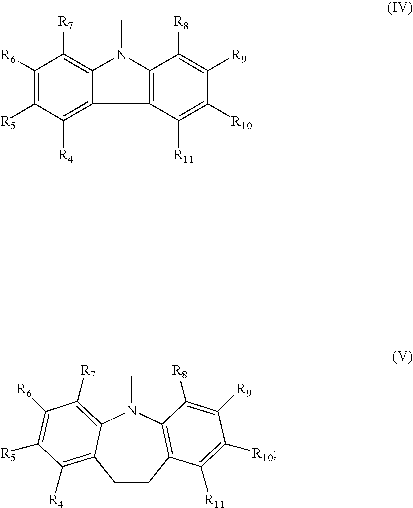
wherein each R₄, R₅, R₆, R₇, R₈, R₉, R₁₀, and R₁₁ are independently selected from the group consisting of H, alkyl, halo, nitro, cyano, alkoxyl, acyl, acyloxy, aryl, aryloxy, aralkyl, aralkoxy, and dialkylamino.

16. The transition metal complex of claim 14, wherein the transition metal complex is selected from the group consisting of:

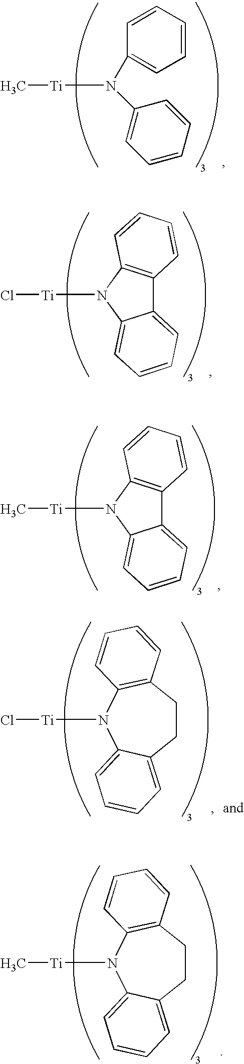

17. An activated catalyst species, wherein the activated catalyst species has a structure of Formula (VI): 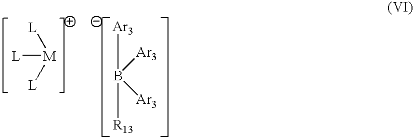
wherein:
M is a transition metal;
each L is a monodentate diarylamido ligand;
each Ar₃ is aryl or substituted aryl; and
R₁₃ is alkyl, aryl, or substituted aryl.

18. The activated catalyst species of claim 17, wherein one or more L has a structure of Formula (III): 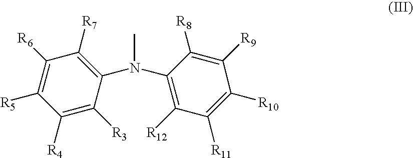
wherein:
each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or
R₃ and R₁₂ together are a direct bond; or
R₃ and R₁₂ together are C₁-C₂ alkylene.

19. The activated catalyst species of claim 17, having an activity of about 20 kg of polymer per mole of catalyst or more.

20. A method of polymerizing a monomer, the method comprising:
providing an activated catalyst species, wherein the activated catalyst species has a structure of Formula (VI): 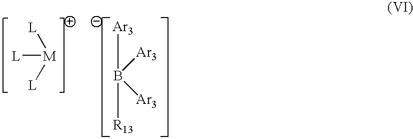
wherein:
M is a transition metal;
each L is a monodentate diarylamido ligand;
each Ar₃ is aryl or substituted aryl; and
R₁₃ is alkyl, aryl, or substituted aryl;
providing a monomer; and
contacting the activated catalyst species with the monomer, thereby polymerizing the monomer to form a polymer.

21. The method of claim 20, wherein one or more L has a structure of Formula (III): 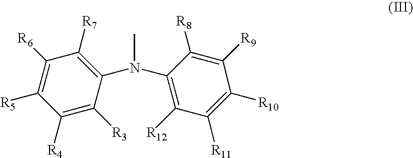
wherein:
each of R₃, R₄, R₅, R₆, R₇, R₈, R₉, R₁₀, R₁₁, and R₁₂ is independently selected from the group consisting of H, alkyl, halo, nitro, cyano, alkoxyl, acyl, acyloxy, aryl, aryloxy, aralkyl, aralkoxy, and dialkylamino; or
R₃ and R₁₂ together are a direct bond; or
R₃ and R₁₂ together are C₁-C₂ alkylene.

22. A polymer, wherein the polymer is prepared by contacting a monomer with an activated catalyst species, said activated catalyst species having a structure of Formula (VI): 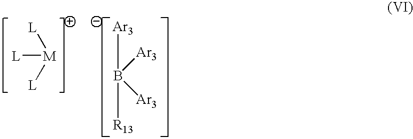
wherein:
M is a transition metal;
each L is a monodentate diarylamido ligand;
each Ar₃ is aryl or substituted aryl; and
R₁₃ is alkyl, aryl, or substituted aryl.

23. The polymer of claim 22, wherein the polymer is polypropylene.

24. The polymer of claim 23, wherein the polypropylene has an average molecular weight (Mw) of about 750,000 or more.
